(19) United States
(12) Patent Application Publication
(10) Pub. No.: US 2026/0104684 A1
(43) Pub. Date: Apr. 16, 2026

(54) Electronic Device, Electronic Apparatus and Control Method Therefor

(71) Applicant: BOE TECHNOLOGY GROUP CO., LTD, Chaoyang District, Beijing (CN)

(72) Inventors: Enhui Guan, Beijing (CN); Youxiang Xia, Beijing (CN)

(21) Appl. No.: 19/116,451

(22) PCT Filed: Apr. 27, 2023
(86) PCT No.: PCT/CN2023/091249

§ 371 Date: May 7, 2025

(51) Int. Cl. G05B 15/02; H04B 1/401

(52) U.S. Cl. CPC G05B 15/02; H04B 1/401

(57) ABSTRACT

An electronic apparatus. The electronic apparatus comprises: a first connector (40), a data detection module (10), a data selector (20), and a first wireless receiving device (30). The data detection module (10) is electrically connected to a first output end (41) of the first connector (40) and a control end (23) of the data selector (20). A first input end (21) of the data selector (20) is electrically connected to a second output end (42) of the first connector (40), to receive a first signal from the first connector (40), and a second input end (22) of the data selector (20) is electrically connected to the first wireless receiving device (30), to receive a second signal from the first wireless receiving device (30). When an input end (43) of the first connector (40) is not suspended, the data selector (20) receives a control signal from the data detection module (10) as a first level signal, and an output end (24) of the data selector (20) outputs the first signal. When the input end (43) of the first connector (40) is suspended, the data selector (20) receives a control signal from the data detection module (10) as a second level signal, and the output end (24) of the data selector (20) outputs the second signal.

### TECHNICAL FIELD

The present disclosure relates to the field of electronic technologies, and in particular, to an electronic device, an electronic apparatus and a control method therefor.

### BACKGROUND

With the continuous development of technologies, the application of remotely controlling various electronic devices is becoming more and more widespread. Regarding this demand, infrared remote controls may be used to remotely control various electronic devices.

An infrared remote control is typically provided with an infrared transmitter, and when using the infrared remote control, people may aim the infrared remote control at an electronic device to be controlled to drive the electronic device.

### SUMMARY

In an aspect, an electronic device is provided. The electronic device includes a first connector, a data detection module, a data selector and a first wireless receiver. The data detection module is electrically connected to a first output terminal of the first connector and a control terminal of the data selector, and the data detection module is configured to transmit a control signal to the data selector under control of a first voltage signal transmitted from the first output terminal of the first connector. A first input terminal of the data selector is electrically connected to a second output terminal of the first connector for receiving a first signal from the first connector, and a second input terminal of the data selector is electrically connected to the first wireless receiver for receiving a second signal from the first wireless receiver. In a case where an input terminal of the first connector is not floating, the control signal received by the data selector from the data detection module is a first level signal; the data selector is configured such that an output terminal of the data selector outputs the first signal under control of the first level signal transmitted from the data detection module. In a case where the input terminal of the first connector is floating, the control signal received by the data selector from the data detection module is a second level signal; the data selector is configured such that the output terminal of the data selector outputs the second signal under control of the second level signal transmitted from the data detection module.

In some embodiments, the data detection module includes a first transistor and a first power terminal. A control electrode of the first transistor is electrically connected to the first output terminal of the first connector, a first electrode of the first transistor is electrically connected to the first output terminal of the first connector; a second electrode of the first transistor, the first power terminal and the control terminal of the data selector are electrically connected to a same first node.

In some embodiments, the data detection module further includes a first protection unit, and the first protection unit is connected between the first node and the first power terminal in series.

In some embodiments, the data detection module further includes a second protection unit, and the second protection unit is connected between the first output terminal of the first connector and the first electrode of the first transistor is series.

In some embodiments, the electronic device further includes a control chip, the control chip is electrically connected to the output terminal of the data selector, and the control chip is configured to receive the first signal or the second signal from the data selector and decode the first signal or the second signal into a data signal to drive the electronic device.

In some embodiments, the control chip includes a decoding unit, a software layer data processing and defining unit, and an output unit; the decoding unit is electrically connected to both the software layer data processing and defining unit and the output terminal of the data selector, and the decoding unit is configured to decode the first signal or the second signal to generate first data; and the software layer data processing and defining unit is electrically connected to the output unit, and the software layer data processing and defining unit is configured to generate a first instruction based on the first data and transmit the first instruction to the output unit.

In some embodiments, the electronic device further includes a first switch unit connected between the output terminal of the data selector and the control chip in series.

In some embodiments, the first switch unit includes a second transistor and a second power terminal; a control electrode of the second transistor is electrically connected to the second power terminal, a first electrode of the second transistor is electrically connected to the output terminal of the data selector, and a second electrode of the second transistor is electrically connected to the control chip.

In some embodiments, the electronic device further includes a second connector, and an input terminal of the second connector is electrically connected to the output terminal of the data selector.

In some embodiments, the electronic device further includes a second switch unit connected between the output terminal of the data selector and the second connector in series.

In some embodiments, the second switch unit includes a third transistor and a third power terminal; a control electrode of a second transistor is electrically connected to the third power terminal, a first electrode of the third transistor is electrically connected to the output terminal of the data selector, and a second electrode of the third transistor is electrically connected to the input terminal of the second connector.

In some embodiments, the electronic device further includes an amplifier connected between the input terminal of the second connector and the output terminal of the data selector in series.

In another aspect, an electronic apparatus is provided. The electronic apparatus includes a plurality of electronic devices that are cascaded and a second wireless receiver. The plurality of electronic devices are each the electronic device according to any one of the above embodiments. The electronic device includes a second connector, and an input terminal of the second connector is electrically connected to the output terminal of the data selector. An input terminal of a first connector of a first electronic device is electrically connected to the second wireless receiver. For two adjacent electronic devices, an input terminal of a first connector of a latter electronic device is electrically connected to an output terminal of a second connector of a former electronic device.

In yet another aspect, a control method for the electronic apparatus described in the above embodiment is provided. The control method includes: for any one of the plurality of electronic devices, a first wireless receiver receiving a code value with an identifier from a remote control and transmitting a second signal containing the code value to a data selector, the second wireless receiver receiving the code value with the identifier from the remote control and transmitting a first signal containing the code value to the data selector via a first connector, a data detection module receiving a first voltage signal from a first output terminal of the first connector and transmitting a control signal to the data selector, the control signal being a first level signal, and the data selector transmitting the first signal to a control chip and a second connector according to the first level signal; the control chip including a first operation state, and in the first operation state, the control chip decoding the first signal to obtain first data to drive target electronic devices.

In some embodiments, the control chip further includes a second operation state, in the second operation state, the control chip obtaining identification information of the electronic device, and in response to that the identification information matches the identifier carried by the code value contained in the first signal, the control chip decoding the first signal to obtain the first data to drive a target electronic device.

In some embodiments, the control method further includes: obtaining identification information of each of the plurality of electronic devices; for two adjacent electronic devices, a control chip of a former electronic device obtaining identification information of the former electronic device and transmitting the identification information of the former electronic device to a latter electronic device via a second connector, and a control chip of the latter electronic device receiving the identification information of the former electronic device from the former electronic device and obtaining identification information of the latter electronic device. The identification information of the former electronic device is different from the identification information of the latter electronic device.

### BRIEF DESCRIPTION OF THE DRAWINGS

In order to describe the technical solutions in the present disclosure more clearly, the accompanying drawings to be used in some embodiments of the present disclosure will be briefly introduced below. Obviously, the accompanying drawings to be described below are merely drawings of some embodiments of the present disclosure, and a person of ordinary skill in the art can obtain other drawings according to those drawings. In addition, the accompanying drawings in the following description may be regarded as schematic diagrams, but are not limitations on actual sizes of products, actual processes of methods and actual timings of signals involved in the embodiments of the present disclosure.

FIG. 1 is a structural diagram of an electronic apparatus, in accordance with some embodiments;

FIG. 2 is a structural diagram of an electronic device, in accordance with some embodiments;

FIG. 3 is a structural diagram of an electronic device, in accordance with some other embodiments;

FIG. 4 is a structural diagram of an electronic device, in accordance with still some other embodiments;

FIG. 5 is a structural diagram of an electronic device, in accordance with still some other embodiments;

FIG. 6 is a structural diagram of an electronic device, in accordance with still some other embodiments;

FIG. 7 is a structural diagram of an electronic device, in accordance with still some other embodiments;

FIG. 8 is a structural diagram of an electronic device, in accordance with still some other embodiments;

FIG. 9 is a structural diagram of an electronic device, in accordance with still some other embodiments;

FIG. 10 is a structural diagram of an electronic device, in accordance with still some other embodiments;

FIG. 11 is a structural diagram of an electronic device, in accordance with still some other embodiments;

FIG. 12 is a structural diagram of an electronic device, in accordance with still some other embodiments;

FIG. 13 is a structural diagram of an electronic device, in accordance with still some other embodiments;

FIG. 14 is a structural diagram of an electronic device, in accordance with still some other embodiments;

FIG. 15 is a structural diagram of an electronic apparatus, in accordance with some other embodiments;

FIG. 16 is a structural diagram of an electronic apparatus, in accordance with still some other embodiments; and

FIG. 17 is a flow diagram of a control method for an electronic apparatus, in accordance with some embodiments.

### DETAILED DESCRIPTION

The technical solutions in some embodiments of the present disclosure will be clearly and completely described below in conjunction with the accompanying drawings. Obviously, the embodiments to be described are merely some but not all embodiments of the present disclosure. All other embodiments obtained by a person of ordinary skill in the art based on the embodiments of the present disclosure should all belong to the protection scope of the present disclosure.

Unless the context requires otherwise, throughout the description and claims, the term “comprise” and other forms thereof such as the third-person singular form “comprises” and the present participle form “comprising” are construed as an open and inclusive meaning, i.e., “including, but not limited to”. In the description of the specification, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms such as “first” and “second” are used for descriptive purposes only, but are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a/the plurality of”means two or more unless otherwise specified.

Some embodiments may be described using the term “connected” and derivatives thereof. The term “connected” should be understood in a broad sense; for example, the term “connected” may represent a fixed connection, a detachable connection or a one-piece connection; it may represent a direct connection or an indirect connection through an intermediate medium. The embodiments disclosed herein are not necessarily limited to the context herein.

The phrase “at least one of A, B and C” has the same meaning as the phrase “at least one of A, B or C”, both including following combinations of A, B and C: only A, only B, only C, a combination of A and B, a combination of A and C, a combination of B and C, and a combination of A, B and C.

As used herein, the term “if”, depending on the context, is optionally construed as “when”, “in a case where”, “in response to determining that” or “in response to detecting”. Similarly, depending on the context, the phrase “if it is determined that” or “if [a stated condition or event] is detected” is optionally construed as “in a case where it is determined that”, “in response to determining that”, “in a case where [the stated condition or event] is detected” or “in response to detecting [the stated condition or event]”.

The phase “applicable to” or “configured to” used herein means an open and inclusive expression, which does not exclude devices that are applicable to or configured to perform additional tasks or steps.

In addition, the use of the phrase “based on” is meant to be open and inclusive, since a process, step, calculation or other action that is “based on” one or more of the stated conditions or values may, in practice, be based on additional conditions or values exceeding those stated.

As used herein, the term such as “about”, “substantially” or “approximately” includes a stated value and an average value within an acceptable range of deviation of a particular value; the acceptable range of deviation may be determined, for example, by a person of ordinary skill in the art, considering measurement in question and errors (i.e., limitations of a measurement system) associated with measurement of a particular quantity.

Exemplary embodiments are described herein with reference to sectional views and/or plan views as idealized exemplary drawings. In the accompanying drawings, thicknesses of layers and sizes of regions are enlarged for clarity. Thus, variations in shape relative to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. For example, an etched region shown to have a rectangular shape generally has a feature of being curved. Therefore, the regions shown in the accompanying drawings are schematic in nature, and their shapes are not intended to show actual shapes of the regions in an apparatus, and are not intended to limit the scope of the exemplary embodiments.

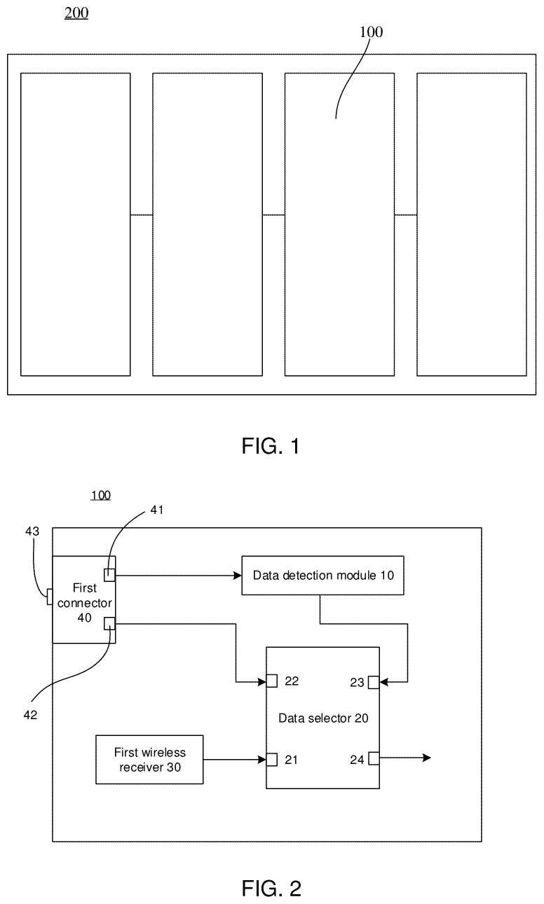

FIG. 1 is a structural diagram of an electronic apparatus, in accordance with some embodiments.

Referring to FIG. 1, some embodiments of the present disclosure provide an electronic apparatus 200.

For example, the electronic apparatus 200 may be any display apparatus that displays images whether in motion (e.g., a video) or stationary (e.g., static images), and whether textual or graphical. More specifically, it is expected that the display apparatus in the embodiments may be implemented in or associated with a variety of electronic apparatuses. The variety of electronic apparatuses may include (but are not limit to), for example, mobile phones, wireless devices, personal data assistants (PDAs), hand-held or portable computers, GPS receivers/navigators, cameras, MP4 video players, video cameras, game consoles, watches, clocks, calculators, TV monitors, flat panel displays, computer monitors, car displays (e.g., odometer displays), navigators, cockpit controllers and/or displays, camera view displays (e.g., rear view camera displays in vehicles), electronic photos, electronic billboards or indicators, projectors, building structures, packagings and aesthetic structures (e.g., a display for an image of a piece of jewelry), etc.

The electronic apparatus 200 includes at least one electronic device 100.

In some examples, the electronic apparatus 200 may include one electronic device 100. It will be understood that, in some other examples, the electronic apparatus may include a plurality of electronic devices 100, and the plurality of electronic devices 100 are cascaded so that adjacent electronic devices 100 are electrically connected to constitute the electronic apparatus 200.

In some embodiments, the electronic apparatus 200 is a tiled display screen consisted of a plurality of electronic devices 100.

The following description is made by taking an example in which the electronic apparatus 200 is a tiled display screen.

FIG. 2 is a structural diagram of an electronic device, in accordance with some embodiments.

Referring to FIG. 2, some embodiments of the present disclosure provide an electronic device 100.

In some examples, the electronic device 100 may be one of an organic light-emitting diode (OLED) electronic device, a quantum dot light-emitting diode (QLED) electronic device, and an MLED (including mini light-emitting diode (LED) or micro LED) electronic device.

With continued reference to FIG. 2, the electronic device 100 includes a first wireless receiver 30, and the electronic device 100 may use the first wireless receiver 30 disposed inside of the electronic device 100 to receive a code value from a remote control and transmit a second signal containing the code value to a control chip of the electronic device 100, so that the electronic device 100 receives the second signal containing the code value, and other modules of the electronic device 100 decode the second signal to drive the electronic device 100.

In some examples, the first wireless receiver 30 may be an infrared receiver. On this basis, the infrared receiver may be used to receive a code value in an infrared format from a remote control. However, some embodiments of the present disclosure are not limited to this.

The inventors have found through researches that, the first wireless receiver 30 is disposed inside of the electronic device 100, so that after the completion of manufacturing the electronic device 100, the model of the first wireless receiver 30 is fixed, which results in poor adaptability of the electronic device 100. Besides, in a case where the first wireless receiver 30 is damaged or otherwise malfunctions, it is not convenient to replace the first wireless receiver 30, which results in a short service life of the electronic device 100.

In some embodiments of the present disclosure, the electronic device 100 further includes a first connector 40, a data detection module 10 and a data selector 20.

The first connector 40 is disposed inside of the electronic device 100. The first connector 40 includes a first output terminal 41 of the first connector 40 and a second output terminal 42 of the first connector 40.

The second output terminal 42 of the first connector 40 is electrically connected to the data selector 20. The second output terminal 42 of the first connector 40 is configured to transmit a code value received from a remote control to the data selector 20 and to transmit a first signal containing the code value to the data selector 20.

The first output terminal 41 of the first connector 40 is electrically connected to the data detection module 10. The first output terminal 41 of the first connector 40 is configured to output a first voltage signal to the data detection module 10 in a case where an input terminal 43 of the first connector 40 is not floating.

In some examples, the case that the input terminal 43 of the first connector 40 is not floating may be understood as that the input terminal 43 of the first connector 40 is electrically connected to, for example, a second wireless receiver, a signal line or other components.

The following description is made by taking an example in which the input terminal 43 of the first connector is electrically connected to a second wireless receiver.

In some examples, the input terminal 43 of the first connector 40 may be located on a side surface of the electronic device 100, so that the second wireless receiver may be electrically connected to the electronic device 100 via the first connector 40, and the electronic device 100 may use the second wireless receiver electrically connected to the first connector 40 to receive a code value from a remote control. Thus, the electronic device 100 may be controlled.

Since the second wireless receiver is not a component integrated inside the electronic device 100 but an external independent component, it is possible to select a second wireless receiver matching the model of the remote control required by the electronic device 100 and make the second wireless receiver electrically connected to the input terminal 43 of the first connector 40, so that the electronic apparatus 200 may use the second wireless receiver to receive a code value from the remote control.

On this basis, the model of the second wireless receiver may be selected according to the model of the remote control, which may help to improve the adaptability of the electronic apparatus 200. Moreover, in a case where the first wireless receiver 30 integrated inside the electronic device 100 is subjected to damage or other malfunctions, the electronic device 100 may directly use the first connector 40 to connect a second wireless receiver externally, so that the second wireless receiver is used to replace the first wireless receiver to prolong the service life of the electronic device 100.

In some examples, the first connector 40 may be a jack audio connection kit (Jack). For example, the first connector 40 may be a 3.5 mm Jack, which is not limited in some embodiments of the present disclosure.

Since the first connector 40 is disposed inside the electronic device 100, and the first connector 40 is electrically connected to the second wireless receiver, the electronic apparatus 200 may not only receive a code value received by the first wireless receiver 30 inside the electronic apparatus 200 but also receive a code value received by the second wireless receiver outside the electronic apparatus 200. In this case, the electronic device 100 may receive two code values, which easily results in mis-operation of the electronic device 100.

In light of this, the data detection module 10 and the data selector 20 are disposed inside the electronic device 100.

The data detection module 10 is electrically connected to the first output terminal 41 of the first connector 40 to receive the first voltage signal from the first output terminal 41 of the first connector 40. The data detection module 10 is configured to generate a control signal under control of the first voltage signal transmitted from the first output terminal 41 of the first connector 40. Moreover, the data detection module 10 is further electrically connected to the data selector 20, and the data detection module 10 is configured to transmit the generated control signal to the data selector 20.

The data selector 20 includes a first input terminal 21, a second input terminal 22 and a control terminal 23.

The first input terminal 21 of the data selector 20 is electrically connected to the second output terminal 42 of the first connector 40 to receive a first signal (containing a code value) from the first connector 40.

The second input terminal 22 of the data selector 20 is electrically connected to the first wireless receiver 30 to receive a second signal (containing a code value) from the first wireless receiver 30.

The control terminal 23 of the data selector 20 is electrically connected to the data detection module 10 to receive the control signal from the data detection module 10.

With the above structure, in a case where the input terminal 43 of the first connector 40 is not floating, the control signal received from the data detection module 10 is a first level signal; the data selector 20 is configured such that an output terminal 24 of the data selector 20 outputs the first signal received by the first input terminal 21 of the data selector 20 under control of a low level signal transmitted from the data detection module 10.

In addition, in a case where the input terminal 43 of the first connector 40 is floating, the control signal received from the data detection module 10 is a second level signal; the data selector 20 is configured such that the output terminal 24 of the data selector 20 outputs the second signal received by the second input terminal 22 of the data selector 20 under the control of the low level signal transmitted from the data detection module 10.

That is, in the electronic device 100, the data detection module 10 and the data selector 20 may cooperate with each other, and the data selector 20 is configured with a priority level; in the case where the input terminal 43 of the first connector 40 is not floating, i.e., the input terminal 43 of the first connector 40 is electrically connected to another component such as the second wireless receiver, the first output terminal 41 of the first connector 40 controls the data detection module 10 to output the control signal (the first level signal) to the data selector 20, so that the data selector 20 preferentially outputs the first signal transmitted from the first connector 40 and ignores the second signal transmitted from the first wireless receiver 30, which may prevent the electronic device 100 from receiving two code values (the first signal and the second signal) to avoid the mis-operation of the electronic device 100.

To sum up, the electronic device 100 provided by some embodiments of the present disclosure includes the data detection module 10, the data selector 20, the first wireless receiver 30 and the first connector 40; the first connector 40 is employed in the electronic device 100, and the electronic device 100 may be electrically connected to an external second wireless receiver via the first connector 40, so that the electronic device 100 may also use the second wireless receiver to receive a code value from a remote control. Furthermore, with the design in which the data detection module 10 and the data selector 20 cooperate with each other and the data selector 20 is configured with the priority level, in the case where the input terminal 43 of the first connector 40 is not floating, the data detection module 10 controls the output terminal 24 of the data selector 20 to preferentially output the first signal transmitted from the first connector 40 and to ignore the second signal transmitted from the first wireless receiver 30, so as to prevent the electronic device 100 from receiving two code values (the first signal and the second signal), thereby preventing the mis-operation of the electronic device 100.

In addition, in a case where the first wireless receiver 30 integrated inside the electronic device 100 is not damaged, the input terminal 43 of the first connector 40 may be set floating; that is, no second wireless receiver is connected to the electronic device 100 via the first connector 40. In this case, the data detection module 10 controls the output terminal 24 of the data selector 20 to preferentially output the second signal transmitted from the first wireless receiver 30, and the control chip inside of the electronic device 100 may decode the second signal to drive the electronic device 100.

Moreover, the second wireless receiver is externally connected to the first connector 40 of the electronic device 100, which facilitates the disassembly, i.e., the replacement, and thus, it may help to improve the adaptability of the electronic apparatus 200. Besides, in the case where the first wireless receiver 30 integrated inside the electronic device 100 is subjected to damages or other malfunctions, the electronic device 100 may directly use the first connector 40 to connect a second wireless receiver externally, so as to use the second wireless receiver to replace the first wireless receiver to prolong the service life of the electronic device 100.

In some possible implementations, devices having a wireless receiver may exist in the environment where the electronic device 100 exists. In this case, when driving other devices having a wireless receiver within a certain range of angle and distance, the wireless receiver of the electronic device 100 may mis-operate and receive a signal transmitted from a remote control that drives other devices having a wireless receiver, which may result in the mis-operation of the electronic device 100.

In view of this, with continued reference to FIG. 2, in some embodiments, the code value received by the second wireless receiver electrically connected to the first connector 40 of the electronic device 100 and received from the remote control may be a code value with an identifier; alternatively, the code value received by the first wireless receiver 30 and from the remote control may be a code value with an identifier. The identifier may be set to match identification information of a target electronic device 100 that the remote control needs to control.

In this way, after the electronic device 100 receives the code value with the identifier, the control chip of the electronic device 100 may be used to decode the first signal containing the code value with the identifier or the second signal containing the code value with the identifier to obtain a corresponding identifier. In a case where the identifier obtained after decoding matches the identification information of the target electronic device 100, the data obtained after decoding the first signal or the second signal may be used to drive the target electronic device 100, which may help to achieve directional control to prevent interference.

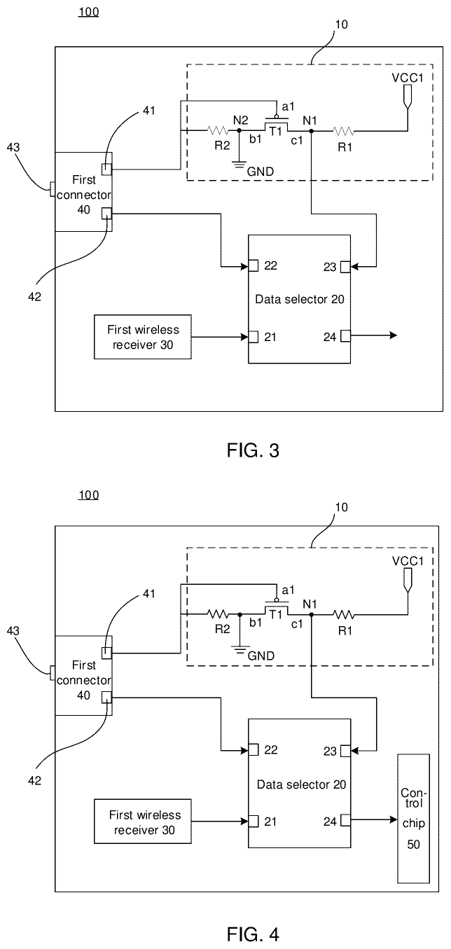

FIG. 3 is a structural diagram of an electronic device, in accordance with some other embodiments.

In some embodiments, referring to FIG. 3, the data detection module 10 includes a first transistor T1 and a first power terminal VCC1.

A control electrode a1 of the first transistor T1 is electrically connected to the first output terminal 41 of the first connector 40; a first electrode b1 of the first transistor T1 is electrically connected to the first output terminal 41 of the first connector 40; a second electrode c1 of the first transistor T1, the first power terminal VCC1 and the control terminal 23 of the data selector 20 are electrically connected to a same first node N1.

The control electrode a1 of the first transistor T1 and the first electrode b1 of the first transistor T1 are both electrically connected to the first output terminal 41 of the first connector 40.

In the case where the input terminal 43 of the first connector 40 is not floating, the first connector 40 is configured such that the first output terminal 41 of the first connector 40 outputs the first voltage signal to the control electrode a1 and the first electrode b1 of the first transistor T1 of the data detection module 10. The first voltage signal is the first level signal.

In this case, the control electrode a1 of the first transistor T1 receives the first level signal from the first connector 40 to control the first transistor T1 to be turned on. The first level signal received from the first connector 40 at the first electrode b1 of the first transistor T1 may be transmitted to the first node N1 through the second electrode c1 of the first transistor T1. Thus, in the data detection module 10, the first level signal output at the first node N1 is transmitted to the control terminal 23 of the data selector 20 as the control signal.

In this way, the data selector 20 may preferentially output the first signal transmitted from the first connector 40 and ignore the second signal transmitted from the first wireless receiver 30 according to the control signal (the first level signal), so as to prevent the electronic device 100 from receiving two code values (the first signal and the second signal), thereby preventing the mis-operation of the electronic device 100.

In the case where the input terminal 43 of the first connector 40 is floating, the first connector 40 is configured such that the first output terminal 41 of the first connector 40 outputs the first voltage signal to the control electrode a1 and the first electrode b1 of the first transistor T1 of the data detection module 10. The first voltage signal is the second level signal.

In this case, the control electrode a1 of the first transistor T1 receives the second level signal from the first connector 40 to control the first transistor T1 to be turned off; the first electrode b1 of the first transistor T1 is floating and the second level signal transmitted from the first connector 40 cannot be transmitted to the first node N1. However, a second level signal provided by the first power terminal VCC1 may be transmitted to the first node N1. In this case, in the data detection module 10, the second level signal output from the first node N1 is transmitted to the control terminal 23 of the data selector 20 as the control signal.

In this way, the data selector 20 may preferentially output the second signal transmitted from the first wireless receiver 30 according to the control signal (the second level signal), and the control chip inside the electronic device 100 may decode the second signal to drive electronic device 100.

In some examples, the first level signal is a low level signal, the second level signal is a high level signal, and the first transistor T1 is a P-type transistor.

In the case where the first transistor T1 is a P-type transistor, the first transistor T1 is turned on in response that the control electrode a1 of the first transistor T1 receives a low level signal, and the first transistor T1 is turned on in response that the control electrode a1 of the first transistor T1 receives a high level signal.

On this basis, in the case where the input terminal 43 of the first connector 40 is not floating, the first output terminal 41 of the first connector 40 outputs a low level signal to the control electrode a1 of the first transistor T1 and the first electrode b1 of the first transistor T1; the control electrode a1 of the first transistor T1 receives the low level signal, so that the first transistor T1 is turned on and the low level signal at the first electrode b1 of the first transistor T1 may be transmitted to the first node N1; the data detection module 10 transmits the low level signal to the control terminal 23 of the data selector 20 as the control signal, and the data selector 20 receives the low level signal and preferentially outputs the first signal transmitted from the first connector 40.

In the case where the input terminal 43 of the first connector 40 is floating, the first output terminal 41 of the first connector 40 outputs a high level signal to the control electrode a1 of the first transistor T1 and the first electrode b1 of the first transistor T1; the control electrode a1 of the first transistor T1 receives the high level signal, so that the first transistor T1 is turned off, then the first electrode b1 of the first transistor T1 is floating, and the high level signal transmitted from the first connector 40 cannot be transmitted to the first node N1. However, the high level signal provided by the first power terminal VCC1 may be transmitted to the first node N1; in this case, the data detection module 10 transmits the high level signal to the control terminal 23 of the data selector 20 as the control signal, and the data selector 20 receives the high level signal and preferentially outputs the second signal transmitted from the first wireless receiver 30.

In some examples, in a case where the electronic device 100 is in a standby state, the first power terminal VCC1 may provide the high level signal.

In some examples, the first power terminal VCC1 may be a power terminal specialized for the data detection module, and the voltage value of the second level signal provided by the first power terminal VCC1 may be adjusted as needed. However, the present disclosure is not limited to this, and the first power terminal VCC1 may be a power terminal that already exists in the electronic device 100.

In some embodiments, with continued reference to FIG. 3, the data detection module 10 further includes a first protection unit R1, and the first protection unit R1 is connected between the first node N1 and the first power terminal VCC in series. The first protection unit R1 may play the role in current limiting and stable protection.

In some examples, the first protection unit R1 includes a resistor. For example, the first protection unit R1 may be a pull-up resistor.

To be specific, by using the first connector 40 and the cooperation of the first protection unit R1 and the first power terminal VCC1, the first node N1 is maintained at the low level in the case where the first transistor T1 is turned on, and the first node N1 is maintained at the high level in the case where the first transistor T1 is turned off.

In some examples, the first protection unit R1 may be a 0402 precision resistor with a resistance accuracy of 5%, and the embodiments of the present disclosure are not limited thereto.

In some embodiments, with continued reference to FIG. 3, the data detection module 10 further includes a second protection unit R2, and the second protection unit R2 is connected between the first output terminal 41 of the first connector 40 and the first electrode b1 of the first transistor T1 in series. The data detection module 10 further includes a ground terminal GND. The ground terminal GND, the second protection unit R2 and the first transistor T1 are electrically connected to a same second node N2. The second protection unit R2 may play the role in current limiting and stable protection.

In some examples, the second protection unit R2 includes a resistor. For example, the second protection unit R2 may be a pull-down resistor.

To be specific, by using the first connector 40 and the cooperation of the second protection unit R2 and the ground terminal GND, the first node N1 is maintained at the low level in the case where the first transistor T1 is turned on, and the first node N1 is maintained at the high level in the case where the first transistor T1 is turned off.

In some examples, the second protection unit R2 may be a 0402 precision resistor with a resistance accuracy of 5%, and the embodiments of the present disclosure are not limited thereto.

FIG. 4 is a structural diagram of an electronic device, in accordance with still some other embodiments.

In some embodiments, referring to FIG. 4, the electronic device 100 further includes a control chip 50; the control chip 50 is electrically connected to the output terminal 24 of the data selector 20; the control chip 50 is configured to receive the first signal or the second signal from the data selector 20 and to decode the first signal or the second signal into a data signal to drive the electronic device 100.

With the cooperation of the first connector, the data detection module 10 and the data selector 20, the data selector 20 is controlled to output the first signal transmitted from the first connector 40 or the second signal transmitted from the first wireless receiver 30. Furthermore, the data selector 20 transmits the first signal or the second signal to the control chip 50, and the control chip 50 decodes the first signal or the second signal and use the data obtained after decoding to drive the electronic device.

In some examples, the control chip 50 may be a system on chip (SoC), and the embodiments of the present disclosure are not limited thereto.

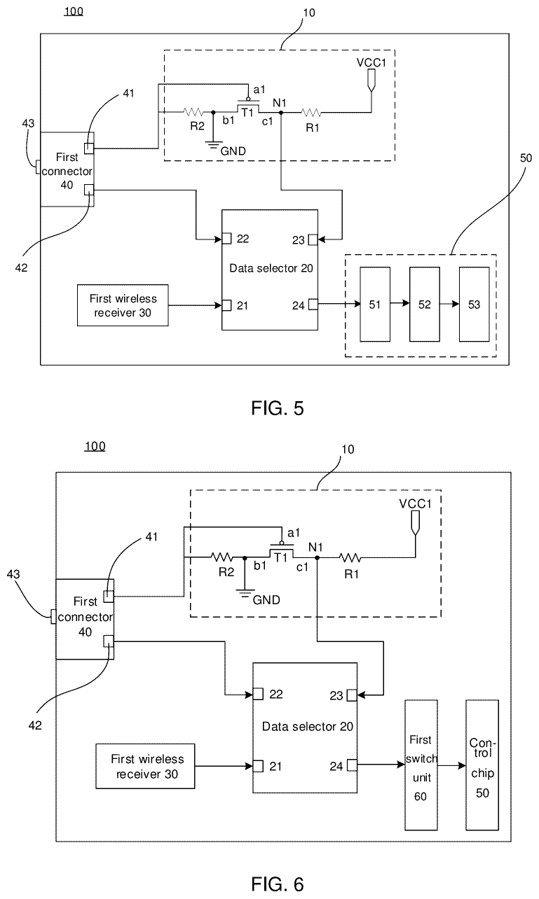

FIG. 5 is a structural diagram of an electronic device, in accordance with still some other embodiments.

In some embodiments, referring to FIG. 5, the electronic device 100 further includes a control chip 50, and the control chip 50 includes a decoding unit 51, a software layer data processing and defining unit 52 and an output unit 53.

The decoding unit 51 is electrically connected to the output terminal 24 of the data selector 20 and is used to decode the first signal or the second signal to obtain first data. The decoding unit 51 is further electrically connected to the software layer data processing and defining unit 52 for receiving the first data from the decoding unit 51 to transmit the first data to the software layer data processing and defining unit 52.

The software layer data processing and defining unit 52 is electrically connected to both the decoding unit 51 and the output unit 53. The software layer data processing and defining unit 52 is used to receive the first data from the decoding unit 51 and generate a first instruction, and the software layer data processing and defining unit 52 outputs the first instruction through the output unit 53 to drive the electronic device 100.

In some examples, referring to FIG. 5, in a case where the electronic device 100 has its identification information, and the code value received from the remote control by the second wireless receiver electrically connected to the first connector 40 is a code value with an identifier or the code value received from the remote control by the first wireless receiver 30 is a code value with an identifier,
the decoding unit 51 is used to decode the first signal or the second signal to obtain the first data and an identifier, and transmit the first data and the identifier obtained by decoding to the software layer data processing and defining unit 52; and
the software layer data processing and defining unit 52 stores the identification information of the electronic device 100 and receives the first data and the identifier from the decoding unit 51; and in response to that the identifier matches the identification information of the target electronic device 100, the software layer data processing and defining unit 52 generates the first instruction based on the first data and transmits the first instruction to the output unit 53 to drive the target electronic device 100.

In this way, directional operation of the electronic device 100 may be achieved based on the received code value with the identifier, which prevents other devices having a wireless receiver from interfering the electronic device 100, and thus it helps to reduce the mis-operation of the electronic device 100.

FIG. 6 is a structural diagram of an electronic device, in accordance with still some other embodiments.

In some embodiments, referring to FIG. 6, the electronic device 100 further includes a first switch unit 60, and the first switch unit 60 is connected between the output terminal 24 of the data selector 20 and the control chip 50 in series.

The first switch unit 60 is disposed between the output terminal 24 of the data selector 20 and the control chip 50, so that the first switch unit 60 may be used to disconnect the output terminal 24 of the data selector 20 and the control chip 50 in the standby state of the electronic device 100 to facilitate low power consumption of the electronic device.

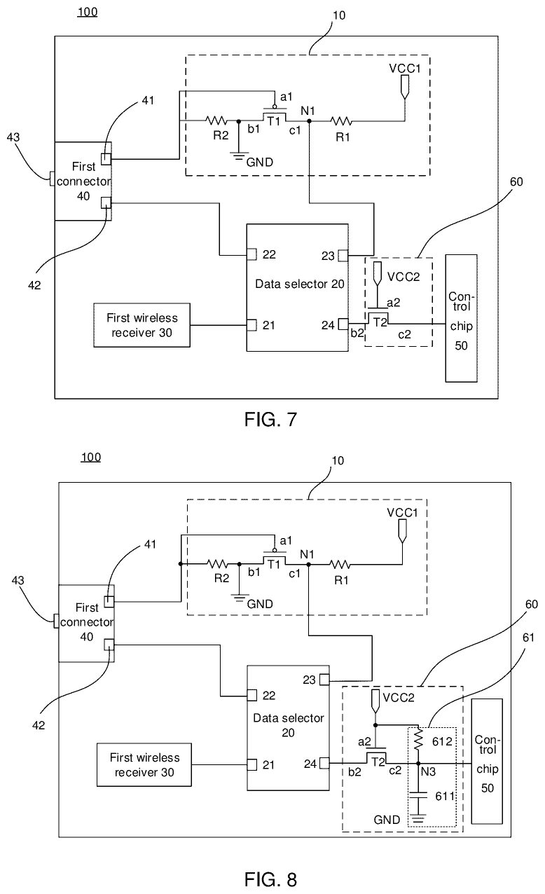

FIG. 7 is a structural diagram of an electronic device, in accordance with still some other embodiments.

In some embodiments, referring to FIG. 7, the electronic device 100 further includes a first switch unit 60, and the first switch unit 60 is connected between the output terminal 24 of the data selector 20 and the control chip 50 in series; the first switch unit 60 includes a second transistor T2 and a second power terminal VCC2.

A control electrode a2 of the second transistor T2 is electrically connected to the second power terminal VCC2, a first electrode b2 of the second transistor T2 is electrically connected to the output terminal 24 of the data selector 20, and a second electrode c2 of the second transistor T2 is electrically connected to the control chip 50.

On this basis, the control electrode a2 of the second transistor T2 receives a power signal from the second power terminal VCC2 to control the second transistor T2 to be turned on, so that the output terminal 24 of the data selector 20 and the control chip 50 are electrically connected normally; that is, the data selector 20 may transmit the first signal or the second signal to the control chip 50.

However, in the case where the electronic device 100 is in the standby state, the second power terminal VCC2 is turned off and cannot continue to provide the power signal; in this case, no power signal is received at the control electrode a2 of the second transistor T2, and the second transistor T2 is controlled to be in an off state, so that the output terminal 24 of the data selector 20 and the control chip 50 are disconnected from each other, which facilitates the low power consumption of the electronic device 100.

In some embodiments, the second power terminal VCC2 may also be used as a system power terminal of the electronic device 100, so that in the standby state of the electronic device 100, the second power terminal VCC2 is turned off and cannot continue to provide the power signal to control the connection between the output terminal 24 of the data selector 20 and the control chip 50.

FIG. 8 is a structural diagram of an electronic device, in accordance with still some other embodiments.

In some embodiments, referring to FIG. 8, the first switch unit 60 further includes a filter 61, and the filter 61 includes a first capacitor 611 and a first resistor 612.

A terminal of the first resistor 612 is electrically connected to the control electrode a2 of the second transistor T2; another terminal of the first resistor 612, a first plate of the first capacitor 611, the second electrode c2 of the second transistor T2 and the control chip 50 are electrically connected to a same third node N3; a second plate of the first capacitor 611 is electrically connected to the ground terminal GND.

The filter 61 is connected between the second transistor T2 and the control chip 50 in series, which may help to improve the stability of the output terminal 24 of the data selector 20 when outputting the first signal or the second signal to the control chip 50.

In some examples, the first resistor 612 may be a 0402 precision resistor with a resistance accuracy of 5%, and the embodiments of the present disclosure are not limited thereto.

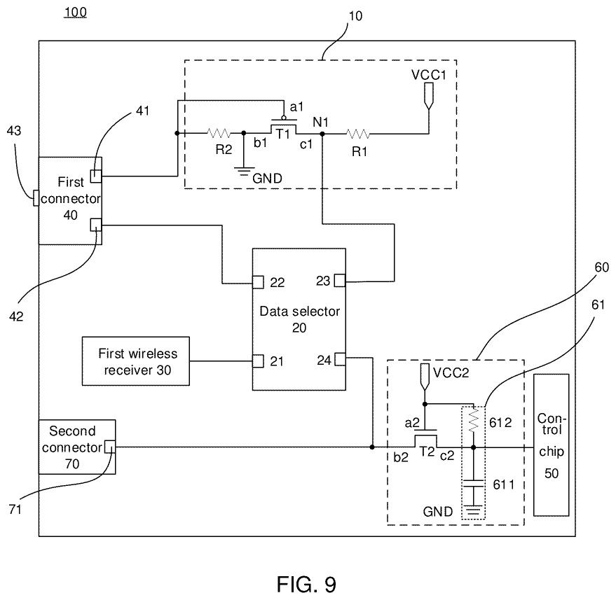

FIG. 9 is a structural diagram of an electronic device, in accordance with still some other embodiments.

In some embodiments, referring to FIG. 9, the electronic device 100 further includes a second connector 70, and an input terminal 71 of the second connector 70 is electrically connected to the output terminal 24 of the data selector 20.

In this way, the output terminal 24 of the data selector 20 is electrically connected to both the control chip 50 and the second connector 70. That is, in the case where the data selector 20 outputs the first signal or the second signal to the control chip 50, the data selector 20 may also output the first signal or the second signal to the second connector 70.

In this case, the electronic device 100 includes both the first connector 40 and the second connector 70; the first connector 40 is equivalent to an input connector of the electronic device 100, and the second connector 70 is equivalent to an output connector of the electronic device 100. That is, the electronic device 100 may use the first connector 40 to connect a second wireless receiver or an external signal line externally to receive signals, and the electronic device 100 may output signals to other devices via the second connector 70.

Furthermore, the electronic device 100 may use the second connector 70 to connect other devices, and the signal output from the second connector 70 of the electronic device 100 may serve as an input signal for other devices electrically connected to the electronic device 100 to drive the electronic device 100 and other devices synchronously. The specific driving method will be described in detail below.

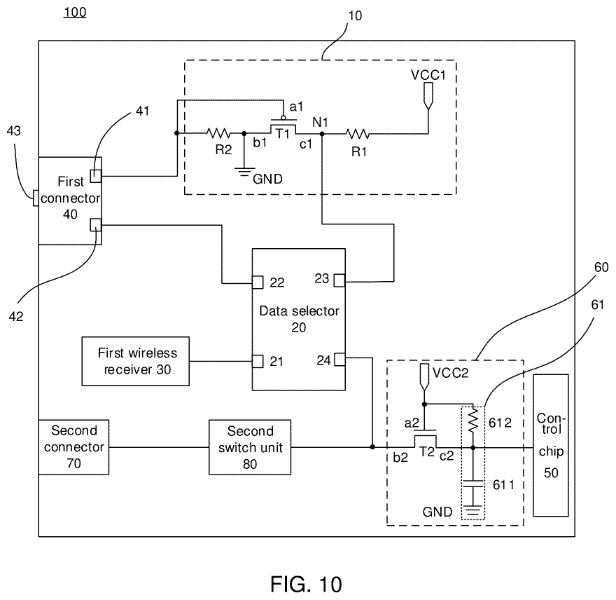

FIG. 10 is a structural diagram of an electronic device, in accordance with still some other embodiments.

In some embodiments, referring to FIG. 10, the electronic device 100 further includes a second switch unit 80, and the second switch unit 80 is connected between the output terminal 24 of the data selector 20 and the second connector 70 in series.

The second switch unit 80 is disposed between the output terminal 24 of the data selector 20 and the second connector 70, so that in the standby state of the electronic device 100, the second switch unit 80 may be used to disconnect the output terminal 24 of the data selector 20 and the second connector 70 to facilitate the low power consumption of the electronic device 100.

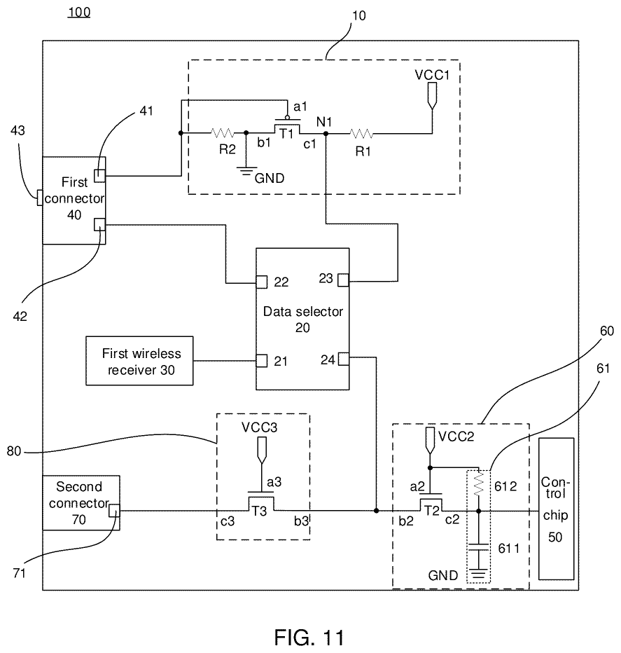

FIG. 11 is a structural diagram of an electronic device, in accordance with still some other embodiments.

In some embodiments, referring to FIG. 11, the electronic device 100 further includes a second switch unit 80, the second switch unit 80 is connected between the output terminal 24 of the data selector 20 and the second connector 70 in series, and the second switch unit 80 includes a third transistor T3 and a third power terminal VCC3.

A control electrode a3 of the second transistor T2 is electrically connected to the third power terminal VCC3, a first electrode b3 of the third transistor T3 is electrically connected to the output terminal 24 of the data selector 20, and a second electrode c3 of the third transistor T3 is electrically connected to the input terminal 71 of the second connector 70.

In this way, the control electrode a3 of the third transistor T3 receives a power signal from the third power terminal VCC3 to control the third transistor T3 to be turned on, so that the output terminal 24 of the data selector 20 and the second connector 70 are electrically connected normally; that is, the data selector 20 may transmit the first signal or the second signal to the second connector 70.

However, in the case where the electronic device 100 is in the standby state, the third power terminal VCC3 is turned off and cannot continue to provide the power signal; in this case, no power signal is received at the control electrode a3 of the third transistor T3, and the third transistor T3 is controlled to be in an off state, so that the output terminal 24 of the data selector 20 and the second connector 70 are disconnected from each other, which facilitates the low power consumption of the electronic device 100.

In some embodiments, the third power terminal VCC3 may also be used as the system power terminal of the electronic device 100, so that in the standby state of the electronic device 100, the third power terminal VCC3 is turned off and cannot continue to provide the power signal to control the connection between the output terminal 24 of the data selector 20 and the second connector 70.

In some embodiments, with continued reference to FIG. 11, the electronic device 100 includes the first switch unit 60 and the second switch unit 80.

The second power terminal VCC2 of the first switch unit 60 and the third power terminal VCC3 of the second switch unit 80 may be the same system power terminal.

In the case where the electronic device 100 is in the standby state, the system power terminal (the second power terminal VCC2 and the third power terminal VCC3) is turned off and cannot continue to provide the power signal, so that the second transistor T2 of the first switch unit 60 and the third transistor T3 of the second switch unit 80 are both in an off state. In this way, the output terminal 24 of the data selector 20 is disconnected from both the control chip 50 and the second connector 70, which helps to reduce the power consumption of the electronic device 100 in the standby state.

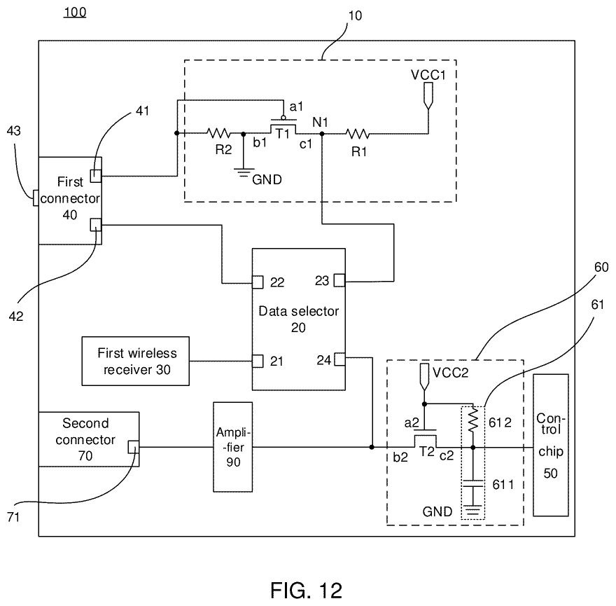

FIG. 12 is a structural diagram of an electronic device, in accordance with still some other embodiments.

In some embodiments, referring to FIG. 12, the electronic device 100 further includes an amplifier 90, and the amplifier 90 is connected between the input terminal 71 of the second connector 70 and the output terminal 24 of the data selector 20.

In the case where the electronic device 100 and other devices are driven as a whole, other devices may be electrically connected to the electronic device 100 via the second connector 70. Thus, while being transmitted to the control chip 50 of the electronic device 100, the first signal or the second signal output by the data selector 20 of the electronic device 100 may also be transmitted to other devices via the second connector 70 to drive the other devices.

On this basis, the amplifier 90 is connected between the input terminal 71 of the second connector 70 and the output terminal 24 of the data selector 20, so that the amplifier 90 may amplify the first signal or the second signal output from the data selector 20 before the first signal or the second signal is output to the second connector 70, so as to compensate the loss during transmission of the first signal or second signal. In this way, the other devices electrically connected to the second connector 70 may receive the amplified first signal or second signal and be driven normally, so that the case that the other devices electrically connected to the second connector 70 cannot be driven due to the loss during transmission of the first signal or second signal may be prevented.

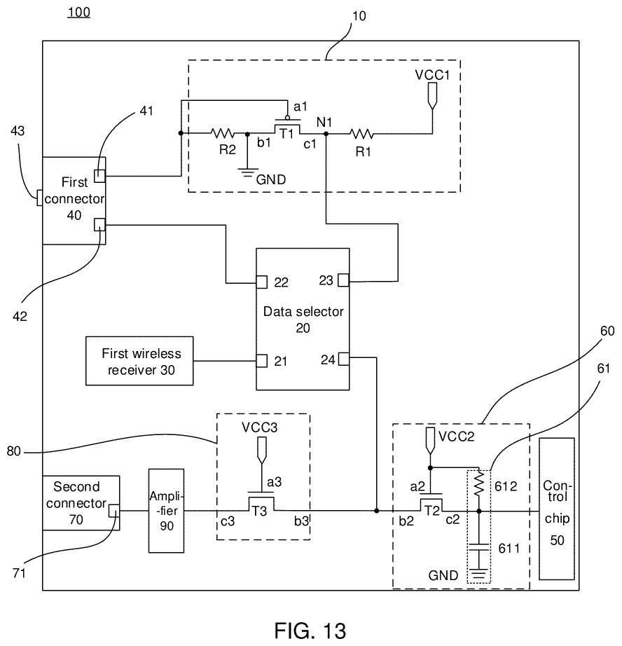

FIG. 13 is a structural diagram of an electronic device, in accordance with still some other embodiments.

In some embodiments, in a case where the electronic device 100 further includes both the second switch unit 80 and the amplifier 90, there may be two placements for the amplifier.

First placement: referring to FIG. 13, the amplifier 90 is connected between the second connector 70 and the second switch unit 80 in series. In this way, in the case where the electronic device 100 is in the standby state and the second switch unit 80 is turned off, the amplifier 90 cannot receive the first signal or the second signal output from the data selector 20, so that there is no need to amplify the first signal or the second signal, which helps to reduce the power consumption in the standby state of the electronic device 100.

Second placement: the amplifier 90 is connected between the second switch unit 80 and the data selector 20 in series. However, some embodiments of the present disclosure are not limited to the placements.

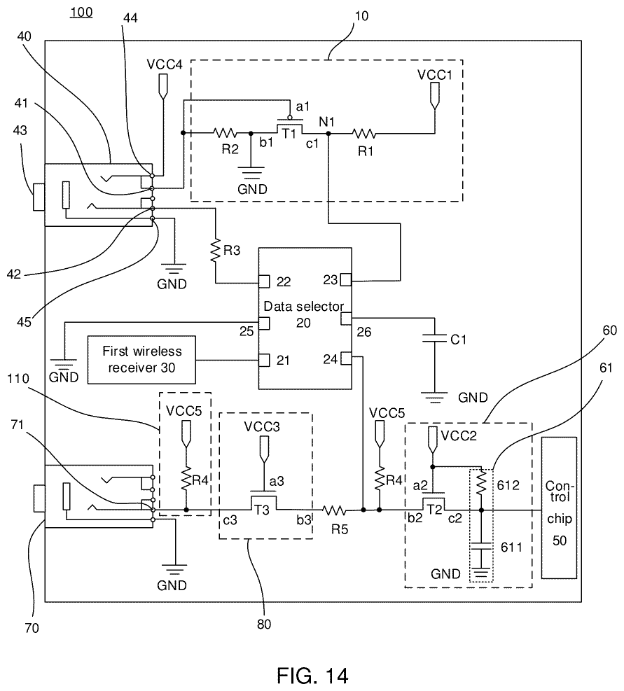

FIG. 14 is a structural diagram of an electronic device, in accordance with still some other embodiments.

In some embodiments, referring to FIG. 14, the first connector 40 of the electronic device 100 further includes a first power contact 44 and a second power contact 45; the first power contact 44 is electrically connected to a fourth power terminal VCC4, and the second power contact 45 is electrically connected to the ground terminal GND.

In this way, the first connector 40 is electrically connected to the fourth power terminal VCC4 and the ground terminal GND, so that the first connector 40 can operate.

In addition, the fourth power terminal VCC4 may be used to allow the first power contact 44 to have a high potential, and the first power contact 44 is electrically connected to the first output terminal 41. Thus, in the case where the input terminal 43 of the first connector 40 is floating, the first voltage signal output from the first output terminal 41 of the first connector 40 may be a high level signal.

In some examples, the fourth power terminal VCC4 may be a power terminal specialized for the first connector 40, and the value of the voltage provided by the fourth power terminal VCC4 may be adjusted as needed. However, the present disclosure is not limited to this, and the fourth power terminal VCC4 may also be used as the power terminal that already exists in the electronic device 100.

In some embodiments, referring to FIG. 14, the data selector 20 of the electronic device 100 further includes a third power contact 25 and a fourth power contact 26.

The third power contact 25 is electrically connected to the ground terminal GND, the fourth power contact 26 is electrically connected to a first capacitor C1, and the fourth power contact 26 is a power contact that is in a high potential. The first capacitor C1 is further electrically connected to the ground terminal GND. In this way, the first capacitor C1 may play the role of filtering to enable the data selector 20 to operate normally.

In some examples, referring to FIG. 14, the electronic device 100 further includes a third protection unit R3 connected between the second input terminal 22 of the data selector 20 and the second output terminal 42 of the first connector 40 in series, and the third protection unit R3 may help to improve the stability of the voltage level output from the second input terminal 22 of the data selector 20.

In some examples, the third protection unit R3 may be a 0402 precision resistor with a resistance accuracy of 5%, and some embodiments of the present disclosure are not limited thereto.

In some embodiments, referring to FIG. 14, the electronic device 100 further includes pull-up units 110, and a pull-up unit 110 includes a fourth resistor R4 and a fifth power terminal VCC5.

In some examples, a pull-up unit 110 is connected between the second connector 70 and the second switch unit 80, so that the fourth resistor R4, the input terminal 71 of the second connector 70 and the second electrode c3 of the third transistor T3 of the second switch unit 80 are electrically connected to a same node. In this way, the pull-up unit 110 may be used to stabilize the potential of the input terminal 71 of the second connector 70 and the potential of the second electrode c3 of the third transistor T3 and play the role of protecting the circuit.

In some examples, another pull-up unit 110 is connected between the data selector 20 and the first switch unit 60, so that the fourth resistor R4, the output terminal 24 of the data selector 20 and the first electrode b2 of the second transistor T2 are electrically connected to a same node. In this way, the another pull-up unit 110 may be used to stabilize the potential of the first electrode b2 of the second transistor T2 and play the role of protecting the circuit.

In some examples, the fourth resistor R4 may be a 0402 precision resistor with a resistance accuracy of 5%, and some embodiments of the present disclosure are not limited thereto.

In some examples, the fourth power terminal VCC4 may be a power terminal specialized for the first connector 40, and the value of the voltage provided by the fourth power terminal VCC4 may be adjusted as needed. However, the present disclosure is not limited to this, and the fourth power terminal VCC4 may be the power terminal that already exists in the electronic device 100.

In some examples, the fourth power terminal VCC4 and the fifth power terminal VCC5 may be the same power terminal. In this way, the number of power terminals to be used is reduced, which may help to save the internal space of the electronic device 100 to facilitate the connections and layout of wiring inside the electronic device 100.

Referring to FIG. 14, in some embodiments, the electronic device 100 further includes a fifth resistor R5; the fifth resistor R5 is connected between the output terminal 24 of the data selector 20 and the first electrode b3 of the third transistor T3 in series and is connected between the first electrode b3 of the third transistor T3 and the control chip 50 in series.

The fifth resistor R5 may be used to stabilize the circuit to prevent from affecting the circuit quality due to the too large signal transmitted between the first electrode b3 of the third transistor T3 and the data selector 20 and between the first electrode b3 of the third transistor T3 and the control chip 50.

In some examples, the fifth resistor R5 may be a 0402 precision resistor with a resistance accuracy of 5%, and some embodiments of the present disclosure are not limited thereto.

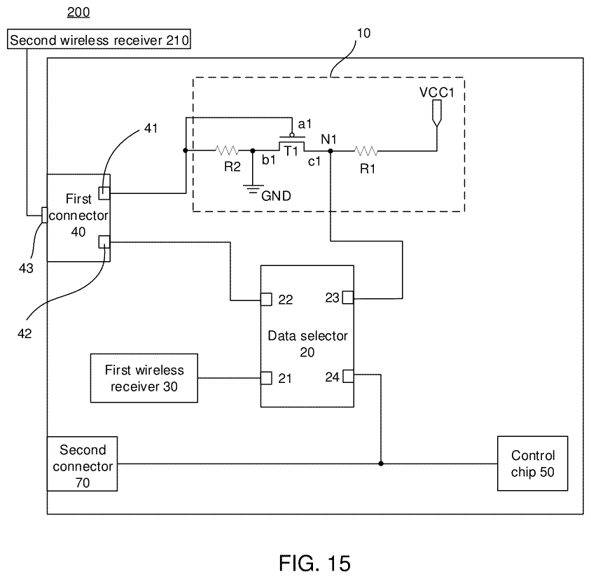

FIG. 15 is a structural diagram of an electronic apparatus, in accordance with some other embodiments.

In some embodiments, referring to FIG. 15, the electronic apparatus 200 includes a second wireless receiver 210 and an electronic device 100; the second wireless receiver 210 may be configured to be electrically connected to the input terminal 43 of the first connector 40.

In this case, the electronic apparatus 200 includes the second wireless receiver 210 and the first wireless receiver 30 inside of the electronic device 100. Thus, the electronic apparatus 200 can use the first wireless receiver 30 inside of the electronic device 100 or the second wireless receiver 210 to receive a code value from a remote control.

The second wireless receiver 210 may receive the code value from the remote control and transmit a first signal containing the code value to the data selector 20 via the first connector 40.

The first wireless receiver 30 may receive the code value from the remote control and transmit a second signal containing the code value to the data selector 20.

Furthermore, the second wireless receiver 210 is electrically connected to the input terminal 43 of the first connector 40, so that the input terminal 43 of the first connector 40 is not floating, and the first output terminal 41 of the first connector 40 may output the first voltage signal to the data detection module 10; in this case, the first voltage signal is the first level signal, and the first level signal output by the data detection module is transmitted to the control terminal 23 of the data selector 20 as a control signal; according to the control signal (the first level signal), the data selector 20 may preferentially output the first signal transmitted from the first connector 40 and ignore the second signal transmitted from the first wireless receiver 30, which may prevent the electronic device 100 from receiving two code values (the first signal and the second signal), thereby preventing the mis-operation of the electronic device 100.

To sum up, in the case where the second wireless receiver 210 of the electronic apparatus 200 is electrically connected to the input terminal 43 of the first connector 40, the electronic device 100 of the electronic apparatus 200 preferentially processes the code value received by the second wireless receiver 210 to drive the electronic apparatus 200; in addition, the second wireless receiver 210 and the first connector 40 are components independent from each other, so that the second wireless receiver 210 may be selected as needed to be electrically connected to the first connector 40 of the electronic device 100, which may help to improve the adaptability of the electronic device 100 and the electronic apparatus 200; moreover, in the case where the first wireless receiver 30 of the electronic device 100 is subjected to damages or malfunctions, the second wireless receiver 210 may be used to replace the first wireless receiver 30 to prolong the service lives of the electronic device 100 and the electronic apparatus 200.

In some examples, the second wireless receiver 210 may be an infrared receiver. On this basis, the infrared receiver may be used to receive a code value in an infrared format from a remote control. However, some embodiments of the present disclosure are not limited to this.

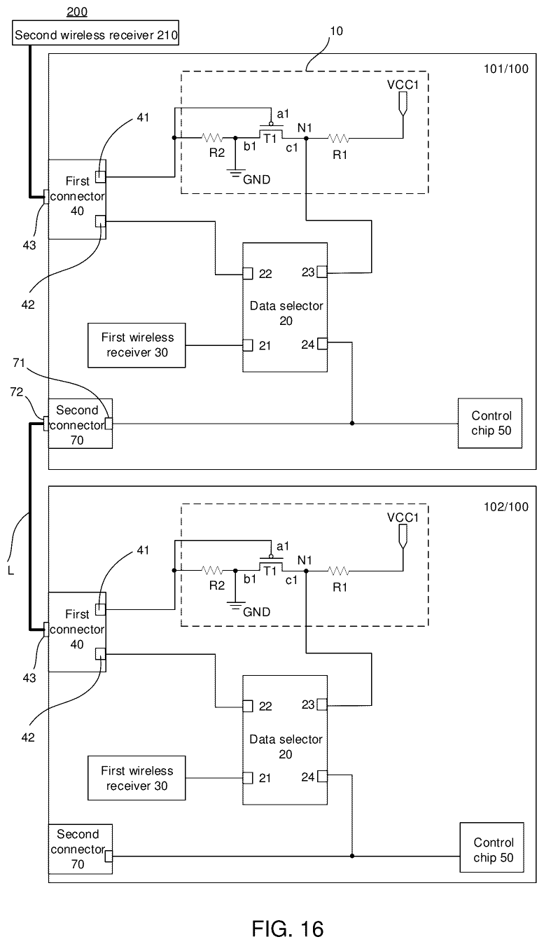

FIG. 16 is a structural diagram of an electronic apparatus, in accordance with still some other embodiments.

Referring to FIG. 16, in some embodiments, the electronic apparatus 200 includes a plurality of electronic devices 100; the electronic devices 100 of the electronic apparatus 200 are close to each other. Thus, when using a remote control to drive a target electronic device 100 of the electronic apparatus 200, other electronic devices around the target electronic device 100 are easily to receive the signal transmitted from the remote control, which may easily result in the mis-operation of the electronic devices 100. Besides, in a case where the plurality of electronic devices 100 of the electronic apparatus 200 need to be driven synchronously, the capabilities of receiving the signal of the electronic devices 100 are different due to the different distances between the remote control and the electronic devices 100, so that the plurality of electronic devices 100 of the electronic apparatus 200 cannot be driven synchronously, which results in low usage efficiency of the electronic apparatus 200.

In some embodiments of the present disclosure, the electronic apparatus 200 includes a plurality of electronic devices 100 that are cascaded and the second wireless receiver 210; the electronic device 100 includes the second connector 70, and the input terminal 71 of the second connector 70 is electrically connected to the output terminal 24 of the data selector 20.

For the plurality of cascaded electronic devices 100, the input terminal 43 of the first connector 40 of the first electronic device 101 is electrically connected to the second wireless receiver 210; for two adjacent electronic devices 100, the input terminal 43 of the first connector 40 of the latter electronic device 100 is electrically connected to the output terminal 72 of the second connector 70 of the former electronic device 100.

The following description is made by taking an example in which a target electronic device 100 of the electronic apparatus 100 is driven.

Among all the cascaded electronic devices, a target electronic device is selected, and identification information of the target electronic device is obtained.

The input terminals 43 of the first connectors 40 of the plurality of electronic devices 100 of the electronic apparatus 200 are not floating, so that the data selectors 20 of the electronic devices 100 all preferentially output the signal received from the first connector 40.

For two adjacent electronic devices 100, the first connector of the latter electronic device 100 is electrically connected to the data selector 20 of the former electronic device via the output terminal 72 of the second connector 70 of the former electronic device. In this way, for the two adjacent electronic devices 100, the first connector 40 of the latter electronic device 100 may receive a first signal output from the data selector 20 of the former electronic device. As a result, the first signal may be transmitted from the first electronic device 101 to other electronic devices stage by stage.

After each electronic device 100 receives the first signal, the control chip 50 of each electronic device 100 obtains the identification information of itself. In the case where the identification information matches the identifier carried by the first signal, it represents that the electronic device 100 is the target electronic device; in this case, the control chip 50 of the electronic device 100 decodes the first signal to obtain first data to drive the target electronic device. In the case where the identification information does not match the identifier carried by the first signal, it represents that the electronic device 100 is not the target electronic device; in this case, the control chip 50 of the electronic device 100 cannot obtain the data for driving the electronic device 100 based on the first signal. Therefore, the code value in the first signal and the identification information of the electronic device are used to effectively prevent the interference between the electronic devices 100 of the electronic apparatus 200, thereby reducing the probability of mis-operation of the electronic device 100.

The following description is made by taking an example in which the two adjacent electronic devices 100 are a first electronic device 101 and a second electronic device 102.

For the first electronic device 101, the following operations may be performed.

The second wireless receiver 210 receives the code value with the identifier from the remote control and transmits a first signal containing the code value to the data selector 20 via the first connector 40. The identifier carried by the code value matches the identification information of the target electronic device; that is, the first signal contains an identifier that matches the identification information of the target electronic device.

The first wireless receiver 30 receives the code value with the identifier from the remote control and transmits a second signal containing the code value to the data selector 20. The identifier carried by the code value matches the identification information of the target electronic device; that is, the second signal contains an identifier that matches the identification information of the target electronic device.

In some examples, the identification information of the electronic device includes a serial number of the electronic device, and some embodiments of the present disclosure are not limited thereto.

The second wireless receiver 210 is electrically connected to the input terminal 43 of the first connector 40, so that the input terminal 43 of the first connector 40 of the first electronic device 101 is not floating, and the first output terminal 41 of the first connector 40 outputs a first voltage signal to the data detection module 10. In this case, the first voltage signal is a first level signal, and the first level signal output by the data detection module is transmitted to the control terminal 23 of the data selector 20 as a control signal. According to the control signal (the first level signal), the data selector 20 preferentially outputs the first signal transmitted from the first connector 40 to the control chip 50 and the second connector 70 of the first electronic device 101.

The control chip 50 of the first electronic device 101 obtains the identification information of the first electronic device 101. For example, the identification information of the first electronic device 101 may include the serial number “1”.

In a case where the identification information of the first electronic device 101 obtained by the control chip 50 of the first electronic device 101 matches the identifier carried by the first signal, it represents that the first electronic device 101 is the target electronic device. In this case, the control chip 50 of the first electronic device 101 decodes the first signal to obtain the first data to drive the target electronic device (the first electronic device 101).

In a case where the identification information of the first electronic device 101 obtained by the control chip 50 of the first electronic device 101 does not match the identifier carried by the first signal, it represents that the first electronic device 101 is not the target electronic device. In this case, the control chip 50 of the first electronic device 101 cannot obtain the data that can drive the first electronic device 101 based on the first signal.

In such case, the data selector 20 outputs the first signal to the second connector 70 and transmits the first signal to the next electronic device (the second electronic device 102) via the second connector 70.

For the second electronic device 102, the following operations may be performed.

The first connector 40 transmits the first signal from the first electronic device 101 to the data selector 20.

The first wireless receiver 30 receives the code value with the identifier from the remote control and transmits a second signal containing the code value to the data selector 20.

The second connector 70 of the first electronic device 101 is electrically connected to the first connector 40 of the second electronic device 102. For example, the second connector 70 of the first electronic device 101 may be electrically connected to the first connector 40 of the second electronic device 102 by a signal line L.

Based on this, the input terminal 43 of the first connector 40 of the second electronic device 102 is also not floating, and the first output terminal 41 of the first connector 40 outputs a first voltage signal to the data detection module 10. In this case, the first voltage signal is a first level signal. The first level signal output by the data detection module is transmitted to the control terminal 23 of the data selector 20 as a control signal. According to the control signal (the first level signal), the data selector 20 preferentially outputs the first signal transmitted from the first connector 40 to the control chip 50 and the second connector 70 of the second electronic device 102.

The control chip 50 of the second electronic device 102 obtains the identification information of the second electronic device 102. For example, the identification information of the second electronic device 102 may include the serial number “2”.

In a case where the identification information of the second electronic device 102 obtained by the control chip 50 of the second electronic device 102 matches the identifier carried by the first signal, it represents that the second electronic device 102 is the target electronic device. In this case, the control chip 50 of the second electronic device 102 decodes the first signal to obtain the first data to drive the target electronic device (the second electronic device 102).

In a case where the identification information of the second electronic device 102 obtained by the control chip 50 of the second electronic device 102 does not match the identifier carried by the first signal, it represents that the second electronic device 102 is not the target electronic device. In this case, the control chip 50 of the second electronic device 102 cannot obtain the data that can drive the second electronic device 102 based on the first signal.

In such case, the second connector 70 of the second electronic device 102 may be used to transmit the first signal to a still next electronic device (a third electronic device 103), and the first signal is downward transmitted stage by stage until all the electronic devices 100 of the electronic apparatus 200 receive the first signal; and it is possible to determine whether the identification information of the device itself matches the identifier carried by the first signal, and only the electronic device 100 whose identification information matches the identifier carried by the first signal is driven based on the first signal. Thus, in the electronic apparatus 200, only the target electronic device is driven based on the first signal.

The operation principles of the electronic devices 100 of the electronic apparatus 200 except the first electronic device 101 are substantially the same as the operation principle of the second electronic device 102. Therefore, for the operation principles of the electronic devices 100 of the electronic apparatus 200 except the first electronic device 101, reference may be made to the description of the operation principle of the second electronic device 102, which will not be repeated here.

The following description is made by taking an example in which the plurality of electronic devices 100 of the electronic apparatus 200 are driven.

For all the cascaded electronic devices, multiple cascaded electronic devices are selected as the target electronic devices.

The input terminals 43 of the first connectors 40 of the multiple electronic devices 100 of the electronic apparatus 200 are not floating, so that the data selectors 20 of the electronic devices 100 each preferentially output the signal transmitted from the first connector 40.

For two adjacent electronic devices 100, the first connector of the latter electronic device 100 is electrically connected to the data selector 20 of the former electronic device via the output terminal 72 of the second connector 70 of the former electronic device. In this way, for the two adjacent electronic devices 100, the first connector 40 of the latter electronic device 100 receives a first signal output from the data selector 20 of the former electronic device. Thus, the first signal transmitted from the first electronic device 101 is transmitted to other electronic devices stage by stage.

After the electronic devices 100 each receive the first signal, the control chips 50 of the electronic devices 100 each decode the first signal and obtains the first data to drive the target electronic devices, so that the multiple electronic devices of the electronic apparatus 200 may be driven as a whole.

After decoding the first signal, the control chip 50 obtains the first data and the identifier carried by the first signal. In this case, the identifier may be a preset identifier, such as any one of “0”, “all”, or “*”, which does not represent a particular meaning; the identification information of each of the electronic devices 100 matches the identifier, such that the first data obtained after decoding the first signal may be used to drive the target electronic devices.

The following description is made by taking an example in which the two adjacent electronic devices 100 are the first electronic device 101 and the second electronic device 102.

For the first electronic device 101, the following operations may be performed.

The second wireless receiver 210 receives the code value with the identifier from the remote control and transmits a first signal containing the code value to the data selector 20 via the first connector 40. The identifier carried by the code value may be a preset identifier, such as any one of “0”, “all”, or “*”, which does not represent a particular meaning; the identification information of each of the electronic devices 100 matches the identifier.

The first wireless receiver 30 receives the code value with the identifier from the remote control and transmits a second signal containing the code value to the data selector 20. The identifier carried by the code value may be a preset identifier, such as any one of “0”, “all”, or “*”, which does not represent a particular meaning; the identification information of each of the electronic devices 100 matches the identifier.

The second wireless receiver 210 is electrically connected to the input terminal 43 of the first connector 40, so that the input terminal 43 of the first connector 40 of the first electronic device 101 is not floating, and the first output terminal 41 of the first connector 40 outputs a first voltage signal to the data detection module 10. In this case, the first voltage signal is a first level signal, and the first level signal output by the data detection module is transmitted to the control terminal 23 of the data selector 20 as a control signal. According to the control signal (the first level signal), the data selector 20 preferentially outputs the first signal transmitted from the first connector 40 to the control chip 50 and the second connector 70 of the first electronic device 101.

The control chip 50 of the first electronic device 101 decodes the first signal to obtain the first data to drive the first electronic device 101.

The second connector 70 transmits the first signal to the latter electronic device (the second electronic device 102). That is, the first connector 40 transmits the first signal from the first electronic device 101 to the data selector 20.

The first wireless receiver 30 receives the code value with the identifier from the remote control and transmits a second signal containing the code value to the data selector 20.

The second connector 70 of the first electronic device 101 is electrically connected to the first connector 40 of the second electronic device 102. For example, the second connector 70 of the first electronic device 101 may be electrically connected to the first connector 40 of the second electronic device 102 by a signal line L.

In this way, the input terminal 43 of the first connector 40 of the second electronic device 102 is also not floating, and the first output terminal 41 of the first connector 40 outputs a first voltage signal to the data detection module 10. In this case, the first voltage signal is a first level signal, and the first level signal output by the data detection module is transmitted to the control terminal 23 of the data selector 20 as a control signal. According to the control signal (the first level signal), the data selector 20 preferentially outputs the first signal transmitted from the first connector 40 to the control chip 50 and the second connector 70 of the second electronic device 102.

The control chip 50 of the second electronic device 102 decodes the first signal to obtain the first data to drive the second electronic device 102.

The second connector 70 of the second electronic device 102 may be used to transmit the first signal to a next electronic device (the third electronic device 103), and the first signal is downward transmitted stage by stage until all the electronic devices 100 of the electronic apparatus 200 receive the first signal, and the electronic devices 100 each decode the first signal to obtain the first data to drive the electronic devices 100. In this way, the multiple electronic devices of the electronic apparatus 200 may be driven as a whole, which improves the efficiency and accuracy of driving the electronic apparatus 200.

The operation principles of the electronic devices 100 of the electronic apparatus 200 except the first electronic device 101 are substantially the same as the operation principle of the second electronic device 102. Therefore, for the operation principles of the electronic devices 100 of the electronic apparatus 200 except the first electronic device 101, reference may be made to the description of the operation principle of the second electronic device 102, which is not repeated here.

To sum up, in the electronic apparatus 200, the second wireless receiver 210 is electrically connected to the input terminal 43 of the first connector 40, and the second connector 70 of the former electronic device 100 is connected to the first connector 40 of the latter electronic device 100, so that the input terminals 43 of the first connectors 40 of all the electronic devices 100 are not floating; thus, the electronic devices 100 of the electronic apparatus 200 preferentially process the code value received from the second wireless receiver 210 to drive the electronic apparatus 200. Furthermore, the identifier carried by the code value may be used to directionally control the target electronic device in the electronic apparatus 200 to prevent the mis-operation of other electronic devices 100 of the electronic apparatus 200. Besides, the cascaded structure and the code value with a special identifier may be used to drive the plurality of electronic devices of the electronic apparatus 200 as a whole, thereby improving the efficiency and accuracy of driving the electronic apparatus 200.

In addition, the second wireless receiver 210 and the first connector 40 are components independent from each other, so that the second wireless receiver 210 may be selected as needed to be electrically connected to the first connector 40 of the electronic device 100, which may help to improve the adaptability of the electronic device 100 and the electronic apparatus 200. Moreover, in the case where the first wireless receiver 30 inside of the electronic device 100 is subjected to damages or malfunctions, the second wireless receiver 210 may be used to replace the first wireless receiver 30 to prolong the service lives of the electronic device 100 and the electronic apparatus 200.

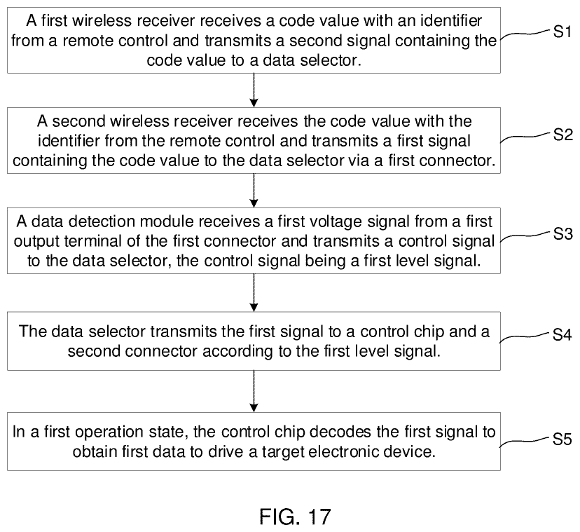

FIG. 17 is a flow diagram of a control method for an electronic apparatus, in accordance with some embodiments.

Some embodiments of the present disclosure provide a control method for an electronic apparatus; the electronic apparatus may be the electronic apparatus 200 shown in FIG. 15 or FIG. 16; for the specific structure of the electronic apparatus 200, reference may be made to the description of the structure of the electronic apparatus 200 in any of the above embodiments, and details are not listed here. The control chip 50 of the electronic device 100 includes a first operation state. In a case where the electronic apparatus 200 needs to drive the plurality of electronic devices 100 of the electronic apparatus 200, the control chip 50 operates in the first operation state.

Referring to FIG. 17, the control method includes the following steps.

In S1, a first wireless receiver 30 receives a code value with an identifier from a remote control and transmits a second signal containing the code value to a data selector 20.

In S2, a second wireless receiver 210 receives the code value with the identifier from the remote control and transmits a first signal containing the code value to the data selector 20 via a first connector 40.

In S3, a data detection module 10 receives a first voltage signal from a first output terminal of the first connector 40 and transmits a control signal to the data selector 20; the control signal is a first level signal.

For the plurality of cascaded electronic devices 100, the input terminal 43 of the first connector 40 of the first electronic device 101 is electrically connected to the second wireless receiver 210. For two adjacent electronic devices 100, the input terminal 43 of the first connector 40 of the latter electronic device 100 is electrically connected to the output terminal 72 of the second connector 70 of the former electronic device 100.

In this way, the input terminals 43 of the first connectors 40 of the plurality of electronic devices 100 of the electronic apparatus 200 are not floating, and the first output terminal 41 of the first connector 40 outputs the first voltage signal to the data detection module 10. The first voltage signal is the first level signal. The first level signal output by the data detection module 10 is transmitted to a control terminal 23 of the data selector 20 as the control signal.

In S4, according to the first level signal, the data selector 20 transmits the first signal to the control chip 50 and the second connector 70.

According to the control signal (the first level signal), the data selector 20 preferentially outputs the first signal transmitted from the first connector 40 and ignores the second signal transmitted from the first wireless receiver 30. In this way, the data selector 20 transmits the first signal to the control chip 50 and the second connector 70.

In S5, in the first operation state, the control chip 50 decodes the first signal to obtain first data to drive a target electronic device 100.

After decoding the first signal, the control chip 50 obtains the first data and an identifier carried by the first signal. In this case, the identifier may be a preset identifier, such as any one of “0”, “all”, or “*”, which does not represent a particular meaning, and the control chip 50 may ignore the preset identifier and use the first data obtained after decoding the first signal to drive the target electronic device.

In this way, for each electronic device 100, the data selector 20 of the electronic device 100 transmits the first signal to the control chip 50; the control chip 50 of each electronic device 100 decodes the first signal, ignores the identifier in the first signal, and obtains the first data from the first signal to drive the target electronic device, thereby driving the plurality of electronic devices 100 of the electronic apparatus 200 as a whole.

For example, a decoding unit 51 of the control chip 50 may decode the first signal to obtain the first data and the identifier, and ignore the identifier, and transmit the first data to a software layer data processing and defining unit 52 of the control chip 50; the software layer data processing and defining unit 52 of the control chip 50 may generate a first instruction based on the first data and transmit the first instruction to an output unit 53 to drive the target electronic device 100.

In this way, with the cascaded structure and the code value with the special identifier, the plurality of electronic devices of the electronic apparatus 200 may be driven as a whole to improve to the efficiency and accuracy of driving the electronic apparatus 200.

In some other embodiments, the control chip 50 of the electronic device 100 includes a second operation state; in the case where the electronic apparatus 200 needs to drive a certain target electronic device of the electronic apparatus 200, the control chip 50 operates in the second operation state.

In the step S5, in the second operation state, the control chip 50 obtains identification information of the electronic device 100; and in response to that the identification information matches the identifier in the code value of the first signal, the control chip 50 decodes the first signal to obtain the first data to drive the target electronic device.

If the identification information matches the identifier carried by the first signal, it represents that the electronic device 100 is the target electronic device. In this case, the control chip 50 of the electronic device 100 decodes the first signal to obtain the first data to drive the target electronic device.

For example, the decoding unit 51 of the control chip 50 decodes the first signal to obtain the first data and the identifier; and in response to that the identifier matches the identification information of the target electronic device 100, the software layer data processing and defining unit 52 of the control chip 50 generates the first instruction based on the first data and transmits the first instruction to the output unit 53 to drive the target electronic device 100.

If the identification information does not match the identifier carried by the first signal, it represents that the electronic device 100 is not the target electronic device. In this case, the control chip 50 of the electronic device 100 cannot obtain the data that can drive the electronic device 100 based on the first signal.

For example, the decoding unit 51 of the control chip 50 decodes the first signal to obtain the first data and the identifier; and in response to that the identifier does not match the identification information of the target electronic device 100, the software layer data processing and defining unit 52 of the control chip 50 cannot generate the first instruction based on the first data and thus cannot drive the target electronic device 100 without the first instruction.

In this way, the electronic device 100 is directionally controlled based on the code value with the identifier, which prevents other devices having a wireless receiver from interfering the electronic device 100, thereby reducing the mis-operation of the electronic device 100.

In some embodiments, with continued reference to FIG. 17, the control method further includes obtaining the identification information of each electronic device 100.

In some examples, in the control method, the identification information of each electronic device 100 is obtained before the step S1.

For two adjacent electronic devices 100, the following operations may be performed.

The control chip 50 of the former electronic device 100 obtains the identification information of the former electronic device 100 and transmits the identification information of the former electronic device 100 to the latter electronic device 100 via the second connector 70.

The control chip 50 of the latter electronic device 100 receives the identification information of the former electronic device 100 from the former electronic device 100 and obtains the identification information of the latter electronic device 100. The identification information of the former electronic device 100 is different from the identification information of the latter electronic device 100.

After the plurality of electronic devices 100 of the electronic apparatus 200 are cascaded, the control chip 50 of the first electronic device 101 (referring to FIG. 16) may be controlled to generate identification information of the first electronic device 101. The control chip 50 of the first electronic device 101 may transmit the identification information of the first electronic device 101 to the second connector 70 of the first electronic device 101, and the identification information of the first electronic device 101 is then transmitted to the first connector 40 of the latter electronic device (the second electronic device 102) via the second connector 70 of the first electronic device 101.

The second output terminal 42 of the first connector 40 of the second electronic device 102 transmits the identification information of the first electronic device 101 to the second input terminal 22 of the data selector 20. Moreover, for the second electronic device 102, since the input terminal of the first connector 40 is not floating, the data detection module 10 controls the data selector 20 to output the identification information of the first electronic device 101 received by the second input terminal of the data selector 20 from the first connector 40. The data selector 20 of the second electronic device 102 outputs the identification information of the first electronic device 101 to the control chip 50 of the second electronic device 102. The control chip 50 of the second electronic device 102 receives and modifies the identification information of the first electronic device 101 to obtain identification information different from the identification information of the first electronic device 101, and uses this identification information as the identification information of the second electronic device 102.

Moreover, similar to the first electronic device 101, the second electronic device 102 transmits the identification information of the second electronic device 102 to a next electronic device (the third electronic device) via the second connector 70 of the second electronic device 102. Thus, the identification information is transmitted to other electronic devices 200 stage by stage such that all the electronic devices of the electronic apparatus 200 each receives its own unique identification information.

To sum up, by arranging the plurality of electronic devices 100 of the electronic apparatus 200 in cascade, the unique identification information of each electronic device 100 may be obtained automatically based on the cascaded structure of the plurality of electronic devices 100, which is conducive to identifying each electronic device 100 of the electronic apparatus 200 by the identification information. In this way, with the identifier carried by the code value transmitted by the remote control, directional control may be achieved, thereby reducing the interference in the electronic apparatus 200.

In some examples, other electronic devices 100 in the electronic apparatus 200 except the first electronic device 100 each may receive identification information of a respective previous electronic device 100 and add “1” to the identification information to obtain new identification information different from the identification information of the previous electronic device 100.

For example, the identification information of the first electronic device 100 is 1; after the identification information “1” is transmitted to the second electronic device 102, the control chip 50 of the second electronic device 102 receives the identification information “1” and add “1” to it to obtain new identification information “2”. In this case, the identification information “2” is used as the identification information of the second electronic device 102. That is, for two adjacent electronic devices 100, the identification information of the latter electronic devices 100 may be obtained by adding “1” to the identification information of the former electronic device.

However, the present disclosure is not limited to the above. It will be understood that the identification information of each electronic device may be multi-bit binary data, and for two adjacent electronic devices 100, the identification information of the latter electronic device 100 may be obtained from the identification information of the former electronic device by binary shifting.

The above are merely specific embodiments of the present disclosure, but the protection scope of the present disclosure is not limited thereto, and variations or substitutions that any person skilled in the art may conceive of within the technical scope of the present disclosure should all fall within the protection scope of the present disclosure. Therefore, the protection scope of the present disclosure should be subjected to the protection scope of the claims.

1. An electronic device, comprising: a first connector, a data detection module, a data selector and a first wireless receiver; wherein
the data detection module is electrically connected to a first output terminal of the first connector and a control terminal of the data selector, and the data detection module is configured to transmit a control signal to the data selector under control of a first voltage signal transmitted from the first output terminal of the first connector;
a first input terminal of the data selector is electrically connected to a second output terminal of the first connector for receiving a first signal from the first connector, and a second input terminal of the data selector is electrically connected to the first wireless receiver for receiving a second signal from the first wireless receiver;
in a case where an input terminal of the first connector is not floating, the control signal received by the data selector from the data detection module is a first level signal; the data selector is configured such that an output terminal of the data selector outputs the first signal under control of the first level signal transmitted from the data detection module; and
in a case where the input terminal of the first connector is floating, the control signal received by the data selector from the data detection module is a second level signal; the data selector is configured such that the output terminal of the data selector outputs the second signal under control of the second level signal transmitted from the data detection module.

2. The electronic device according to claim 1, wherein the data detection module includes a first transistor and a first power terminal; and
a control electrode of the first transistor is electrically connected to the first output terminal of the first connector, a first electrode of the first transistor is electrically connected to the first output terminal of the first connector; a second electrode of the first transistor, the first power terminal and the control terminal of the data selector are electrically connected to a same first node.

3. The electronic device according to claim 2, wherein the data detection module further includes a first protection unit, and the first protection unit is connected between the first node and the first power terminal in series.

4. The electronic device according to claim 2 or 3, wherein the data detection module further includes a second protection unit, and the second protection unit is connected between the first output terminal of the first connector and the first electrode of the first transistor is series.

5. The electronic device according to any one of claims 1 to 4, further comprising: a control chip, wherein the control chip is electrically connected to the output terminal of the data selector, and the control chip is configured to receive the first signal or the second signal from the data selector and decode the first signal or the second signal into a data signal to drive the electronic device.

6. The electronic device according to claim 5, wherein the control chip includes a decoding unit, a software layer data processing and defining unit, and an output unit;
the decoding unit is electrically connected to both the software layer data processing and defining unit and the output terminal of the data selector, and the decoding unit is configured to decode the first signal or the second signal to generate first data; and
the software layer data processing and defining unit is electrically connected to the output unit, and the software layer data processing and defining unit is configured to generate a first instruction based on the first data and transmit the first instruction to the output unit.

7. The electronic device according to claim 5 or 6, further comprising a first switch unit connected between the output terminal of the data selector and the control chip in series.

8. The electronic device according to claim 7, wherein the first switch unit includes a second transistor and a second power terminal; and
a control electrode of the second transistor is electrically connected to the second power terminal, a first electrode of the second transistor is electrically connected to the output terminal of the data selector, and a second electrode of the second transistor is electrically connected to the control chip.

9. The electronic device according to any one of claims 1 to 8, further comprising a second connector, wherein an input terminal of the second connector is electrically connected to the output terminal of the data selector.

10. The electronic device according to claim 9, further comprising a second switch unit connected between the output terminal of the data selector and the second connector in series.

11. The electronic device according to claim 10, wherein the second switch unit includes a third transistor and a third power terminal; and
a control electrode of a second transistor is electrically connected to the third power terminal, a first electrode of the third transistor is electrically connected to the output terminal of the data selector, and a second electrode of the third transistor is electrically connected to the input terminal of the second connector.

12. The electronic device according to any one of claims 9 to 11, further comprising an amplifier connected between the input terminal of the second connector and the output terminal of the data selector in series.

13. An electronic apparatus, comprising: a plurality of electronic devices that are cascaded and a second wireless receiver, wherein the plurality of electronic devices are each the electronic device according to any one of claims 1 to 12; the electronic device includes a second connector, and an input terminal of the second connector is electrically connected to the output terminal of the data selector; and
an input terminal of a first connector of a first electronic device is electrically connected to the second wireless receiver; for two adjacent electronic devices, an input terminal of a first connector of a latter electronic device is electrically connected to an output terminal of a second connector of a former electronic device.

14. A control method for the electronic apparatus according to claim 13, wherein
the control method comprises:
for any one of the plurality of electronic devices,
a first wireless receiver receiving a code value with an identifier from a remote control and transmitting a second signal containing the code value to a data selector,
the second wireless receiver receiving the code value with the identifier from the remote control and transmitting a first signal containing the code value to the data selector via a first connector,
a data detection module receiving a first voltage signal from a first output terminal of the first connector and transmitting a control signal to the data selector, wherein the control signal is a first level signal, and
the data selector transmitting the first signal to a control chip and a second connector according to the first level signal; and
the control chip including a first operation state, and
in the first operation state, the control chip decoding the first signal to obtain first data to drive target electronic devices.

15. The control method according to claim 14, wherein the control chip further includes a second operation state; and
in the second operation state, the control chip obtaining identification information of the electronic device, and in response to that the identification information matches the identifier carried by the code value contained in the first signal, the control chip decoding the first signal to obtain the first data to drive a target electronic device.

16. The control method according to claim 15, further comprising: obtaining identification information of each of the plurality of electronic devices, and
for two adjacent electronic devices,
a control chip of a former electronic device obtaining identification information of the former electronic device and transmitting the identification information of the former electronic device to a latter electronic device via a second connector; and
a control chip of the latter electronic device receiving the identification information of the former electronic device from the former electronic device and obtaining identification information of the latter electronic device, wherein the identification information of the former electronic device is different from the identification information of the latter electronic device.
